(19) United States
(12) Patent Application Publication
(10) Pub. No.: US 2003/0145195 A1
(43) Pub. Date: Jul. 31, 2003

(54) BIOS call technique for operating system device driver

(76) Inventors: Michael R. Garrett, Cypress, TX (US); John S. Lacombe, Austin, TX (US)

Correspondence Address: JONATHAN M. HARRIS, CONLEY, ROSE & TAYON, P.O. BOX 3267, HOUSTON, TX, 77253-3267, US

(21) Appl. No.: 10/062,147

(22) Filed: Jan. 31, 2002

(51) Int. Cl. G06F 15/177

(52) U.S. Cl. 713/2

(57) ABSTRACT

The specification discloses a system and related method for accessing Basic Input/Output System (BIOS) routines in a computer system having a single microprocessor and multiple software streams, or a multiple microprocessor system. In particular, BIOS routines that modify shared variables, or groups of BIOS routines, are opened for use by a calling software stream to the exclusion of other software streams. After performing desired tasks, the calling software stream closes the BIOS routine or groups of routines, thus making them available to other software streams. In this way, access to shared variables using the BIOS routines is synchronized ensuring that overlapping access, and the corresponding potential for errors, is eliminated.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The preferred embodiments of the present invention are related to calling of Basic Input/Output System (BIOS) routines. More particularly, the preferred embodiments are directed to a synchronization method for calling BIOS routines where the BIOS routines modify shared variables and parameters accessed by multiple software streams.

2. Background of the Invention

There are some variables and parameters in computer systems that need to be accessed by multiple software streams, yet these variables are tied to a particular owner. A few examples of such parameters are environment variables and integrated management logs, which are generally updated and maintained by Basic Input/Output System (BIOS) routines. Environment variables may give an indication as to the setup and preferred operation of the computers system, as well as status of various components of the computer system. An integrated management log may store indications of recoverable and non-recoverable faults in a computer system. Regardless of the specific type of variable or parameter that is maintained through BIOS routines, problems exist with regard to how to allow multiple BIOS calling software programs or threads to correctly read and modify these variables.

Consider for purposes of explanation a computer system having a single microprocessor with a first software stream needing to increment a BIOS maintained variable. The first software stream accesses the current status of the variable through the use of a BIOS routine. The return value of the BIOS routine may be the variable of interest. If in the interim between the read by the first software stream and a subsequent write (for example, during a time when the first software stream is preempted), a second software stream writes the variable through the use of a BIOS routine, then the subsequent write by the first software stream produces an incorrect result. In order to alleviate potential problems such as these, related art software streams calling BIOS routines are given an extremely high priority level, thus alleviating the possibility of their preemption. However, assuring BIOS routine synchronization in this manner creates problems. In particular, artificially inflating the priority level of a software stream merely for the purpose of synchronizing access to the variables degrades system performance, as other software streams with true high priority are not executed.

While raising the priority level for the software streams that call BIOS routines may alleviate synchronization problems in a single processor system, this method does not alleviate potential synchronization problems in a multiprocessor system. That is, raising the priority level of a software stream on a first microprocessor does not stop another software stream on a second microprocessor from accessing the shared variables through BIOS routines. In such multiprocessor systems, the related art technique has been to designate a single kernel mode program (a driver program) to be responsible for all communications to BIOS routines. That is, rather than all driver programs attempting to access BIOS routines directly, the driver programs communicate with a designated driver program which facilitates the communication to the BIOS routines. The designated driver program thus synchronizes access to possibly conflicting calls of BIOS routines. However, this related art solution has its drawbacks as well. In particular, it may be difficult, if not impossible, to know which computer system program is vested with the responsibility of facilitating BIOS calls. Moreover, the driver program responsible for facilitating communication is itself subject to preemption which thus may create relatively high latencies for access to BIOS routines.

Thus, what is needed in the art is a way to synchronize access to shared variables maintained by BIOS routines that does not rely on artificially inflating the priority of the BIOS routine calling software or designating a single driver program to call BIOS routines to ensure synchronization.

### BRIEF SUMMARY OF SOME OF THE PREFERRED EMBODIMENTS

The problems noted above are solved in large part by a method of synchronizing access to BIOS routines by requiring programs that call BIOS routines to open the BIOS, or a particular set of routines, to receive an open handle. After receiving a valid open handle, the calling software may read and update the variables as required. Once the reading and updating are complete, the calling program closes the BIOS or BIOS routines. Preferably only one owner for the BIOS or particular set of BIOS routines is allowed at any one time. Thus, the possibility of multiple software streams, for example multiple driver programs, simultaneously accessing variables maintained through the use of BIOS routines is alleviated, as only one owner exists at any one time.

More particularly, in the preferred embodiments of the present invention, BIOS routines related to accessing and updating shared variables maintained through BIOS calls are grouped for single ownership. When a software stream desires access to, or updating capability of, a shared variable, the software stream preferably requests ownership or opens the particular set of BIOS routines. If ownership of the BIOS routines is not already allocated to another software stream, the open function preferably returns an open handle, which preferably includes an identification number. Thereafter, the software stream accesses the various BIOS routines, each time passing the identification number supplied in the open handle. The BIOS routines preferably verify, before BIOS routine execution, that the calling software stream is indeed the owner of the routine or group of routines. After verification, the called BIOS routine preferably executes the desired function, for example, reading or updating a shared variable. After completion, the software stream that owns the group of BIOS routines closes the routines, or relinquishes ownership, and thus other software streams are allowed to request ownership and perform operations. If a second software stream attempts to open the group of BIOS routines while the open handle for those routines is held by another software stream, the BIOS merely returns an indication that the group of BIOS routines is already owned, and preferably the second software stream attempts to open or gain ownership at a later time.

Execution priority of the software streams calling the BIOS routines need not be artificially inflated, thus no adverse impact on system performance should be present. However, synchronization to the shared variables and parameters is assured. Also, there is no need to rely on a single device driver to synchronize access.

### BRIEF DESCRIPTION OF THE DRAWINGS

For a detailed description of the preferred embodiments of the invention, reference will now be made to the accompanying drawings in which:

FIG. 1 shows a computer system of the preferred embodiment;

FIG. 2 shows a flow diagram of the open, use, close procedure for BIOS calls in the preferred embodiment; and

FIG. 3 shows a flow diagram of handling an open request of the preferred embodiment.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . .”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

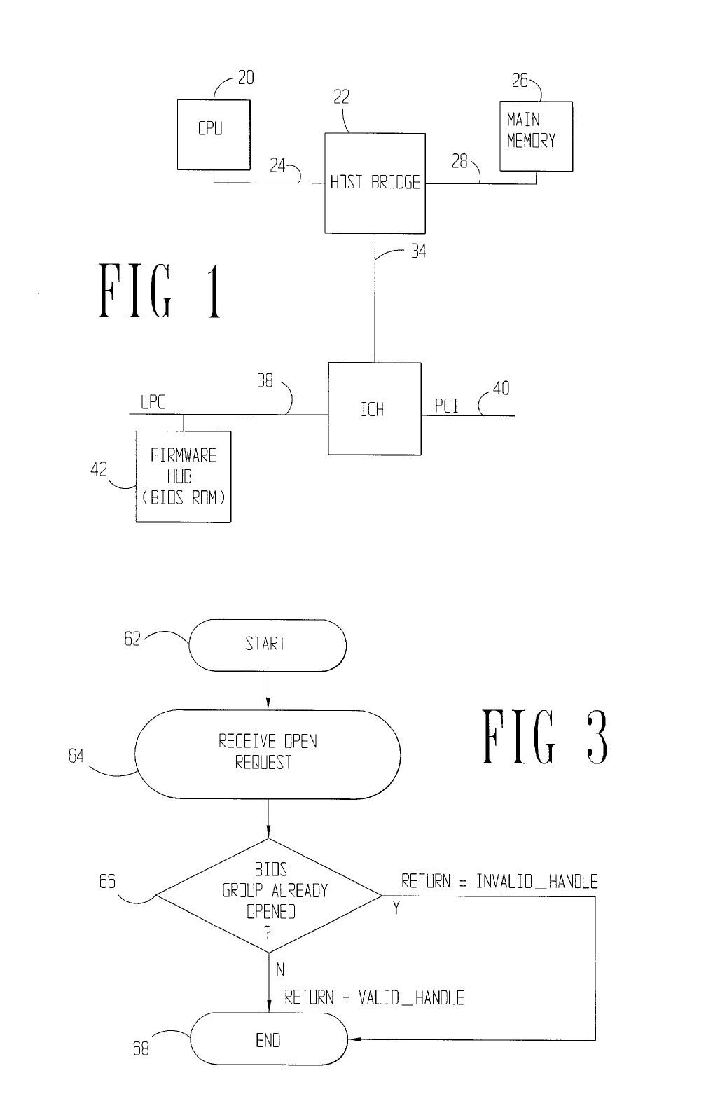

FIG. 1 shows a computer system 100 constructed in accordance with the preferred embodiment. Computer system 100 generally comprises a microprocessor or CPU 20 coupled to a main memory 26 and various other peripheral computer system components, through an integrated host bridge 22. The CPU 20 preferably couples to the host bridge 22 via a host bus 24, or the host bridge logic 22 may be integrated into the CPU 20. The CPU 20 preferably comprises an Itanium™ microprocessor manufactured by Intel Corporation. It should be understood, however, that computer system 100 could comprise other types and brands of microprocessors as well. For example, computer system 100 may comprise a Pentium III™ or Pentium IV™ microprocessor, or any microprocessor later developed, by Intel Corporation. The CPU 100 may also comprise any microprocessor made by Advanced Micro Devices. Thus, the computer system may implement other bus configurations or bus bridges in addition to, or in place of, those shown in FIG. 1. Moreover, computer system 100 could also comprise several microprocessors, as may be used in applications such as a server system.

Main memory 26 preferably couples to the host bridge 22 through a memory bus 28. The host bridge 22 preferably comprises a memory control unit (not shown) that controls transactions to the main memory 26 by asserting the necessary control signals during memory accesses. The main memory 26 functions as the working memory for the CPU 20 and generally comprises a conventional memory device or array of memory devices in which programs, instructions and data are stored. The main memory 26 may comprise any suitable type of memory such as dynamic random access memory (DRAM) or any of the various types of DRAM devices such as synchronous DRAM (SDRAM), extended data output DRAM (EDO DRAM), or Rambus™ DRAM (RDRAM).

The computer system 100 also preferably comprises a graphics controller or video driver card 30 that couples to the host bridge 22 via an Advanced Graphics Port (“AGP”) bus 32, or other suitable type of bus. Alternatively, the video driver card may couple to the primary expansion bus 34 or one of the secondary expansion buses, for example, PCI bus 40. Graphics controller 30 further couples to a display device 32 which may comprise any suitable electronic display device upon which any image or text can be represented.

The computer system 100 also preferably comprises a second bridge logic device 36 that bridges the primary expansion bus 34 to various secondary buses such as a low pin count (LPC) bus 38 and a peripheral component interconnect (“PCI”) bus 40. In accordance with the preferred embodiment the bridge device 36 comprises an Input/Output Controller Hub (“ICH”) manufactured by Intel Corporation. Although the ICH is shown in FIG. 1 only to support the LPC bus 38 and PCI bus 40, various other secondary buses may be supported by the ICH 36.

In the preferred embodiment shown in FIG. 1, the primary expansion bus 34 comprises a Hub-link bus which is a proprietary bus of Intel Corporation. However, computer system 100 is not limited to any particular type of chipset and thus the primary expansion bus may comprise any other suitable buses.

Referring still to FIG. 1, a firmware hub 42 couples to the ICH 36 by way of the LPC bus 38. The firmware hub 46 preferably comprises Read Only Memory (ROM) which contains software programs executable by the CPU 20. The software programs preferably comprise not only programs to implement Basic Input/Output System (BIOS) commands, but also include instructions executed during and just after power on self test (POST) procedures. These software programs perform various functions including verifying proper operation of various system components before control of the system is turned over to the operating system.

In broad terms, the preferred embodiments of the present invention are directed to synchronizing access by software streams to BIOS routines. The preferred embodiments were developed in the context of software streams accessing shared variables through the use of BIOS routines, and thus the following description is related to the context of development; however, the description in this manner should not be construed as a limitation as to the scope of applicability of the concepts described.

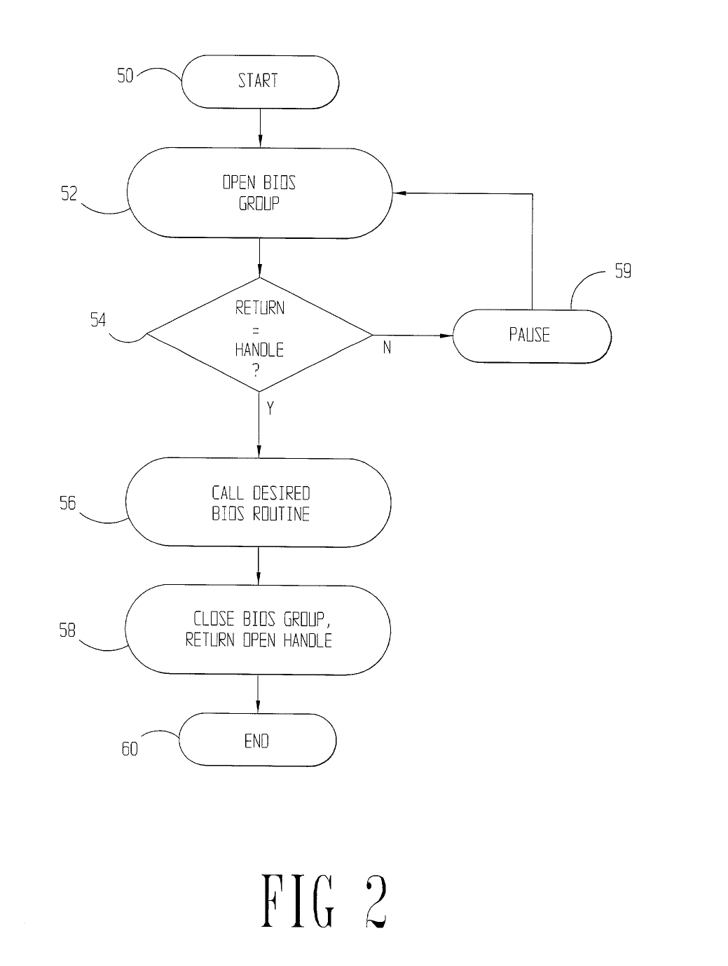

FIG. 2 shows a flow diagram which exemplifies the preferred procedure for a software thread or stream calling BIOS routines. In particular, the process starts at step 50 and proceeds directly to the step of opening the BIOS group (step 52). For some BIOS routines in a computer system, no synchronization is required, and thus these BIOS routines need not be opened and closed as described in the preferred embodiments. While it would be possible to require software streams to open and close the entire BIOS before executing any BIOS routines, preferably only certain groups of routines, those groups that manage access to shared variables, are opened and closed as described in the preferred embodiment. Moreover, opening a BIOS group should not necessarily be construed to mean that more than one BIOS routine should be grouped for opening and closing purposes. It is possible that even a single BIOS routine, where that BIOS routine requires synchronization between multiple software streams, may comprise a BIOS group. Thus, in step 52, the calling software program attempts to open the BIOS group. Preferably, the next step in the procedure is to examine the return value from the open procedure (step 52). More particularly, if the return value is a valid handle (step 54), then the process continues to step 56 where the calling software stream, now holding the valid handle, is allowed to call BIOS routines to perform the desired operation on the shared variables. If, however, the return value from step 52 is not a valid handle, indicating that the BIOS is already opened and owned by another software stream, then preferably the calling software stream pauses momentarily (step 58) and again attempts to open the BIOS group (step 52).

Once the software stream has completed its desired task with respect to the shared variables, the software stream preferably closes the BIOS group (step 58) effectively returning the open handle, and the process ends (step 60).

Consider for purposes of explanation a first software stream and a second software stream, the software streams either executed on the same microprocessor or on different microprocessors. Further consider that both software streams need to access and/or update shared variables maintained through the use of BIOS routines. Still referring to FIG. 2, consider that the first stream is the first to attempt to open the particular BIOS group of interest. In such a case, the first software stream moves through steps 50, 52, 54 and 56 of FIG. 2. Consider also that the second software stream is the second to attempt to access the BIOS routines. In this case, the second software stream progresses through steps 50, 52 and 54 of FIG. 2, but because the particular BIOS group is already open and owned by the first software stream, the return value from the attempt to open the BIOS group is not a valid handle. Thus, the second software stream begins a process of circularly attempting to open the BIOS group (step 52), examining the return value for indications of a proper handle (step 54), pausing (step 58), and attempting again to open the BIOS group (again step 52).

Once the first software stream completes the necessary operations with regard to the shared variables, the first software stream closes the BIOS group and returns the handle (step 58), and the process with regard to the first software stream ends (step 60). However, once the first software stream returns the handle, the handle again becomes available for allocation. As soon as the handle becomes available and the second software stream enters the open BIOS group step (step 52), the second software stream is passed a valid handle and the second software stream may perform its desired updating of the shared variables.

In the exemplary case of two software streams attempting to update the same shared variable, synchronization is provided by the preferred opening, owning and closing the particular BIOS group that performs the desired function. In such a circumstance, there is no need to artificially inflate the execution priority of either the first or second software streams, nor is there a need for either stream to ascertain and utilize a designated driver program to obtain access to the BIOS routines.

FIG. 3 shows a flow diagram of the open request process on the receiving end. In particular, the process preferably starts at step 62, and the first step thereafter is the receipt of an open request by a software stream (step 64). After receipt of the open request, a decision is made regarding whether the particular BIOS group is already opened (step 66). If the BIOS group has not been previously opened, then the return value is set to be a valid handle, and the process ends (step 68) (returning a valid handle). If, however, the BIOS group has already been opened, then the return value is set to an invalid handle, and the process ends (step 68).

Although the steps described above may be implemented in any computer system, in the preferred embodiment, the steps are implemented in a system having at least one Itanium™ microprocessor made by Intel Corporation. As one of ordinary skill in the art is aware, in systems operating with an Itanium™ microprocessor and related chipset, BIOS routine calls are made to a System Abstraction Layer (SAL). For more information regarding the Itanium™ processor family system extraction layer, reference may be had to Intel document No. 245359-003 titled “Itanium™ Processor Family System Abstraction Layer Specification,” dated January 2001, incorporated herein by reference as if reproduced in full below. Thus, rather than the traditional loading of a services number into a register of the microprocessor and issuing a software interrupt, in the Itanium™ system kernel mode software preferably communicates in a C language format function call with the system abstraction layer to request BIOS type services. While certain BIOS routines are generic to every computer system, OEMs have the ability to specify and use custom BIOS routines. Thus, additional routines may be added to the system abstraction layer of the Itanium™ processor family. In the preferred embodiments, implementing the open, use and close technique for routines that modify shared variables preferably takes place at the SAL level of the computer in a C language format function call. However, the same procedures and steps may be implemented directly at the BIOS routine level without departing from the scope and spirit of this invention.

The above discussion is meant to be illustrative of the principles and various embodiments of the present invention. Numerous variations and modifications will become apparent to those skilled in the art once the above disclosure is fully appreciated. For example, the embodiments above are described in the context of an open, use, close system; however, any system in which one or more BIOS routines (even if implemented through a system abstraction layer as in an Itanium™ system) are assigned to a software stream to the exclusion of other streams for synchronization purposes would be within the contemplation of this invention. This specification describes only the preferred implementation of accomplishing the task. One of ordinary skill in the art, now understanding the concept described, could design equivalent systems. It is intended that the following claims be interpreted to embrace all such variations and modifications.

What is claimed is:

1. A method accessing a Basic Input/Output System (BIOS) routine comprising:
requesting exclusive ownership of the BIOS routine by a software stream;
receiving an indication by the software stream of the results of the requesting step; and if the requesting exclusive ownership step is successful
using the BIOS routine by the software stream; and
returning the BIOS routine by the software stream for use by other software streams.

2. The method of accessing a BIOS routine as defined in claim 1 wherein receiving an indication by the software stream of the results of the requesting step further comprises receiving an open handle by the software stream if the requesting exclusive ownership step is successful.

3. The method of accessing a BIOS routine as defined in claim 2 wherein receiving an indication by the software stream of the results of the requesting step further comprises receiving a number representing a valid handle by the software stream if the requesting exclusive ownership step is successful.

4. The method of accessing a BIOS routine as defined in claim 2 wherein receiving an indication by the software stream of the results of the requesting step further comprises receiving a number representing an invalid handle by the software stream if the requesting exclusive ownership step is unsuccessful.

5. The method of accessing a BIOS routine as defined in claim 2 wherein returning the BIOS routine by the software stream for use by the other software streams further comprises closing the BIOS routine by the software stream such that the other software streams may be granted exclusive ownership.

6. The method of accessing a BIOS routine as defined in claim 5 wherein closing the BIOS routine by the software stream further comprises returning the open handle.

7. A computer system comprising:
a microprocessor;
a main memory array;
a first bridge logic device coupling the microprocessor and main memory array;
a graphics controller coupled to the first bridge logic device;
a video display coupled to the graphics controller;
a second bridge logic device coupled to the first bridge logic device by way of a primary expansion bus;
a Read Only Memory (ROM) coupled to the second bridge logic device by way of a secondary expansion bus, the ROM storing Basic Input/Output System (BIOS) routines;
a software stream executed by the microprocessor, the software stream calls BIOS routines; and
wherein the software stream requests exclusive ownership of a BIOS routine prior to its use, and if the software stream is granted exclusive ownership, the software stream uses the BIOS routine and then returns the exclusive ownership.

8. The computer system as defined in claim 7 wherein the software steam is further adapted to request ownership again if exclusive ownership is denied.

9. The computer system as defined in claim 7 wherein the software stream receives a valid handle to the BIOS routine if the software stream is granted exclusive ownership of the BIOS routine.

10. The computer system as defined in claim 7 wherein the software stream returns exclusive ownership by returning the valid handle.

11. The computer system as define in claim 7 wherein the software stream receives an invalid handle to the BIOS routine if the software stream is not granted exclusive ownership of the BIOS routine.

12. In a computer system having a microprocessor executing a software thread, the software thread adapted to call Basic Input/Output System (BIOS) routines, a method of calling BIOS routines comprising:
opening the BIOS routines by the software thread to the exclusion of other software threads;
using the BIOS routines by the software thread; and
closing the BIOS routines by the software thread when the utilizing step is complete.

13. The method of calling BIOS routines as defined in claim 12 wherein opening the BIOS routines by the software thread to the exclusion of other software threads further comprises requesting exclusive ownership of the BIOS routines by the software thread.

14. The method of calling BIOS routines as defined in claim 13 wherein opening the BIOS routines by the software thread to the exclusion of other software threads further comprises receiving an open handle if the requesting exclusive ownership step is successful.

15. The method of calling BIOS routines as defined in claim 13 wherein opening the BIOS routines by the software thread to the exclusion of other software threads further comprises receiving an invalid handle if the requesting exclusive ownership step is unsuccessful.

16. The method of calling BIOS routines as defined in claim 12 wherein opening the BIOS routines by the software thread to the exclusion of other software threads further comprises receiving an open handle if the opening the BIOS routines step is successful.

17. The method of calling BIOS routines as defined in claim 16 wherein closing the BIOS routines by the software thread when the utilizing step is complete further comprises returning the open handle.

18. In a computer system with a microprocessor, main memory and a read only memory storing Basic Input/Output System (BIOS) routines, a method of operating the BIOS routines comprising:
receiving a request for permission to use the BIOS routines;
checking whether permission has been previously granted; and
granting permission to use the BIOS routines if permission has not been previously granted.

19. The method of operating the BIOS routines as defined in claim 18 wherein granting permission to use the BIOS routines if permission has not been previously granted further comprises returning a valid handle of the BIOS routines.

20. The method of operating the BIOS routines as defined in claim 18 further comprising denying permission to use the BIOS routines if permission has been previously granted.

21. The method of operating the BIOS routines as defined in claim 20 wherein denying permission to use the BIOS routines if permission has been previously granted further comprises returning an invalid handle of the BIOS routines.
